(19) United States
(12) Patent Application Publication
(10) Pub. No.: US 2023/0230454 A1
(43) Pub. Date: Jul. 20, 2023

(54) SYSTEMS AND METHODS FOR MULTI-STATE GAME FEATURES

(71) Applicant: SG Gaming, Inc., Las Vegas, NV (US)

(72) Inventors: Christopher Guerrero, Las Vegas, NV (US); George Bouvier, Henderson, NV (US)

(21) Appl. No.: 17/579,347

(22) Filed: Jan. 19, 2022

(51) Int. Cl. G07F 17/32; G07F 17/34

(52) U.S. Cl. CPC G07F 17/3267; G07F 17/3213; G07F 17/34

(57) ABSTRACT

A gaming system comprises game-logic circuitry and a display device that presents a wagering game having a plurality of states, where each state has substantially the same expected value, the same set of available outcomes, and a respective unique set of weight parameters associated with the set of available outcomes. The game-logic circuitry selects a first state for a first duration that has a first set of weight parameters, generates at least one game outcome from the available outcomes based on the first set of weight parameters and one or more random values, causes the display device to present the generated at least one game outcome, randomly selects a state for a second duration following the first duration, and generates one or more game outcomes through the second duration based on the respective set of weight parameters associated with the randomly selected state and one or more random values.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2022, SG Gaming, Inc.

### FIELD

The present disclosure relates generally to gaming systems, apparatus, and methods and, more particularly, to multi-state game features.

### BACKGROUND

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation.

Another significant technical challenge is to provide players with desirable game features within the scope of regulatory considerations with efficient use of computing resources. For example, game features may aim to provide increased player focus on one or more game elements for potential winning outcomes to create enhanced “near-miss” opportunities. However, excessive focus may diminish the value of other game elements, both from a player engagement standpoint and the underlying mathematical configuration of the game feature. Accordingly, it is desirable for at least some game features to dynamically focus on various game elements throughout a gaming feature. At least some known game features aim to achieve this dynamic focus by rearranging or replacing certain game elements to visually increase the number of game elements presented to the player. These known game features may solve player engagement through this method of dynamic focus, but also introduce new regulatory and technical challenges. More specifically, gaming regulatory bodies may limit or prevent the reorganization and/or replacement of game elements, and the reorganization and/or replacement of game elements introduce another layer of computing tasks for generating and presenting game outcomes, thereby increasing the computing resource burden of the game features on a gaining computing device. Accordingly, new and improved means of providing game features with dynamic focus are desired.

As the industry matures, the creativity and ingenuity required to improve such operation of gaining apparatus and games grows accordingly.

### SUMMARY

According to one aspect of the present invention, a gaming system comprises game-logic circuitry and a display device that presents a wagering game having a plurality of states, where each state has substantially the same expected value, the same set of available outcomes, and a respective unique set of weight parameters associated with the set of available outcomes. The game-logic circuitry selects a first state for a first duration that has a first set of weight parameters, generates at least one game outcome from the available outcomes based on the first set of weight parameters and one or more random values, causes the display device to present the generated at least one game outcome, randomly selects a state for a second duration following the first duration, and generates one or more game outcomes through the second duration based on the respective set of weight parameters associated with the randomly selected state and one or more random values. The gaming system may be incorporated into a single, freestanding gaming machine.

According to another aspect of the invention, a method of conducting a wagering game using a gaming system is provided. The gaining system comprises game-logic circuitry and a display device of a gaming machine. The method comprises presenting, by the display device, the wagering game having a plurality of states, wherein each state has substantially the same expected value, the same set of available outcomes relative to the other states, and a respective unique set of weight parameters associated with the set of available outcomes. The method further comprises electing, by the game-logic circuitry, a first state for a first duration that has a first set of weight parameters associated with the set of available outcomes, generating, by the game-logic circuitry, at least one game outcome from the set of available outcomes through the first duration at least partially based on the first set of weight parameters and one or more random values, causing, by the game-logic circuitry, the display device to present the generated at least one game outcome, randomly selecting, by the game-logic circuitry, a state from the plurality of states for a second duration following the first duration, and generating, by the game-logic circuitry, one or more game outcomes from the set of available outcomes through the second duration based on the respective set of weight parameters associated with the randomly selected state and one or more random values.

According to yet another aspect of the invention, a gaming machine comprises a display device and game-logic circuitry. The display device is configured to present a wagering game having a plurality of states, wherein each state has substantially the same expected value, the same set of available outcomes relative to the other states, and a respective unique set of weight parameters associated with the set of available outcomes. The game-logic circuitry is configured to select a first state for a first duration that has a first set of weight parameters associated with the set of available outcomes, generate at least one game outcome from the set of available outcomes through the first duration at least partially based on the first set of weight parameters and one or more random values, cause the display device to present the generated at least one game outcome, randomly select a state from the plurality of states for a second duration following the first duration, and generate one or more game outcomes from the set of available outcomes through the second duration based on the respective set of weight parameters associated with the randomly selected state and one or more random values.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to one or more embodiments of the present disclosure.

FIG. 2 is a schematic view of a gaming system according to one or more embodiments of the present disclosure.

FIG. 3 is an image of an exemplary basic-game screen of a wagering game displayed on a gaming machine, according to one or more embodiments of the present disclosure.

FIG. 4 is a flow diagram of an example method of conducting a multi-state game using a gaming system, according to one or more embodiments of the present disclosure.

FIG. 5A is an example game interface of a game feature in a first state, according to one or more embodiments of the present disclosure.

FIG. 5B is an example game interface of the game feature shown in FIG. 5A in a second state, according to one or more embodiments of the present disclosure.

FIG. 5C is an example game interface of the game feature shown in FIG. 5A in a third state, according to one or more embodiments of the present disclosure.

While the invention is susceptible to various modifications and alternative forms, specific embodiments have been shown by way of example in the drawings and will be described in detail herein. It should be understood, however, that the invention is not intended to be limited. to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

As used herein, the terms “state,” “game state,” and “game feature state” refer to different configurations of the elements that form a game feature, such as the weight parameters that affect the random selection of symbols or other game elements to populate a game interface. The game feature elements are stored instructions, variables, and/or other suitable data elements that the gaming computing device conducting the game feature executes or references to generate the game feature for a gaming session. Different states may partially overlap or be completely distinct from each other. For example, in the example embodiments described herein, all outcomes of the game feature are available between a plurality of states (i.e., the symbols or other game elements that make up the outcomes are available in each of the states), but the weight parameters of the game elements are different to emphasize a particular game element or combination of game elements. The configuration of each state may be predetermined or dynamic such that game events or conditions modify the configuration of a state. Other distinctions between states may be present and are considered within the spirit and scope of the present disclosure, including those distinctions described elsewhere herein.

As used herein, the terms “expected value” (EV), “return-to-player” (RTP), “payback percentage,” and the like refer to the average value output back to the player (i.e., through awards) relative to the value input by the player to play in a wagering game. The EV of a game is calculated based on the available awards, the probabilities of achieving these awards, and the available wagers. Calibration of EV for a particular game feature may be performed by adjusting the weight parameters to favor certain outcomes over other outcomes, activating or deactivating certain functionalities of the game feature, adjusting the available wager amounts, and/or other suitable means of altering the underlying algorithm(s) of the game feature. EV may be defined at different levels of the game, such as by the game state, game feature, or the game as a whole. Calibration of EV at a game state level enables different game states of a game feature to have the same or different EVs. Maintaining EV at the same value between game states may be beneficial to maintain player expectations of the game feature and avoid regulatory restrictions. However, providing different EVs between states may be beneficial for providing game states with enhanced awards (e.g., an award or bonus game state). These changes to the EV of various games stats are reflected in the EV of the game feature and the game as a whole.

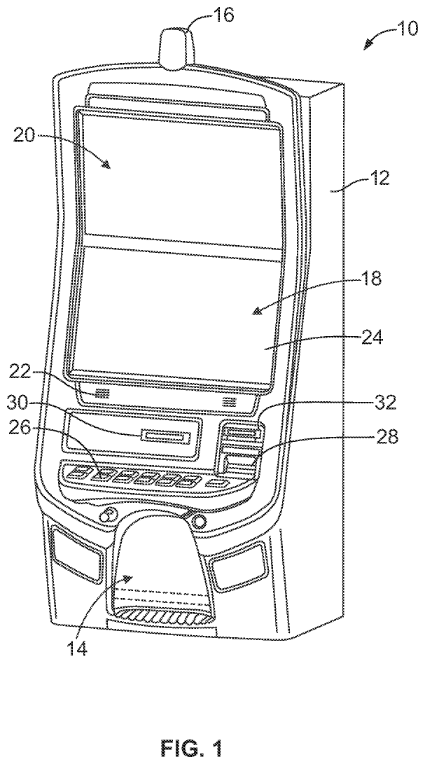

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in sonic aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, entails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.), It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

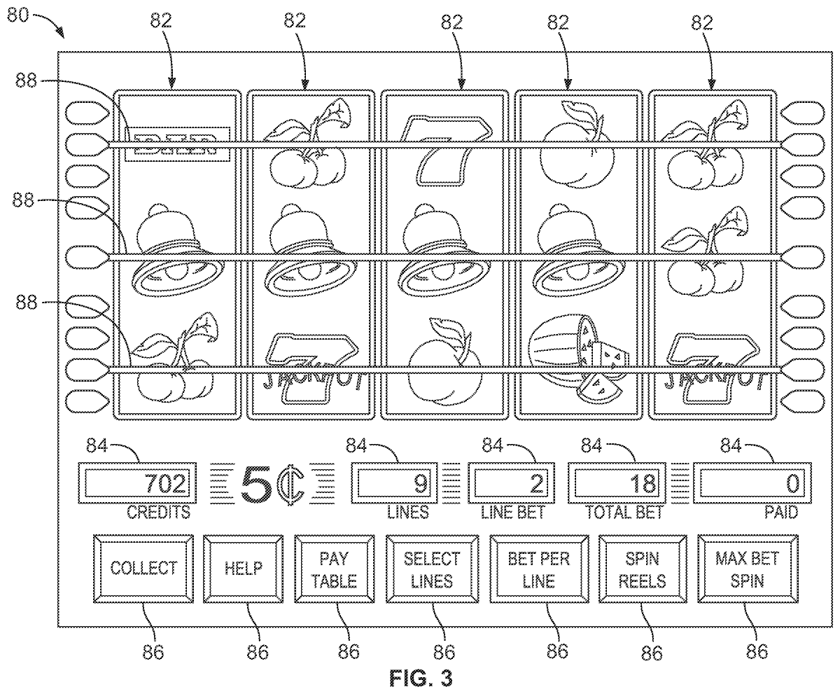

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 84 (see FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 84 (see FIG. 3), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

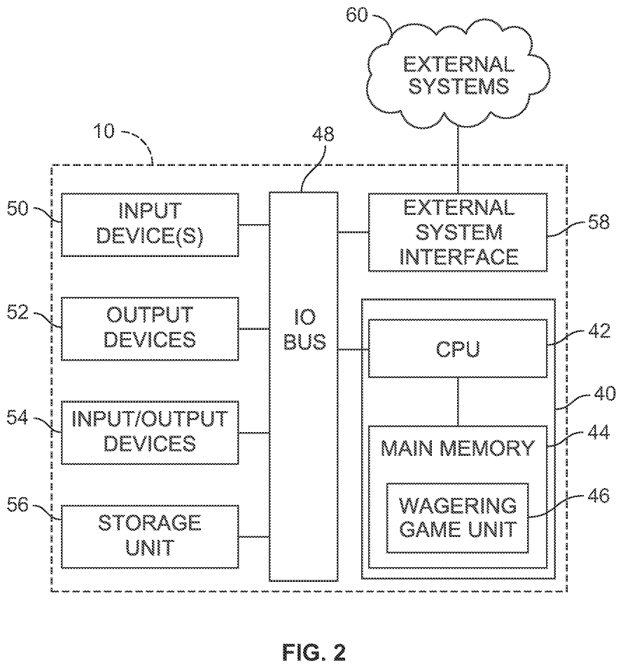

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and ANS. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The 110 bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. in general, the main memory 44 stores programming for a random number generator (RNG), game-outcome logic, and game assets (e.g., art, sound, etc.—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the TING programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RING, the game outcome may be derived from random numbers generated by a physical RNG that measures some physical phenomenon that is expected to be random and then compensates for possible biases in the measurement process. Whether the RNG is a pseudo-RING or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RING is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROW random access memory (RAM), magnetic-disk storage media, optical storage media, flash memory, etc.

Referring now to FIG. 3, there is illustrated an image of a basic-game screen 80 adapted to be displayed on the primary display 18 or the secondary display 20. The basic-game screen 80 portrays a plurality of simulated symbol-beating reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager covered by or deducted from the credit balance on the “credits” meter 84, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act, Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

The systems and methods described herein relate to a multi-state game feature, where each state emphasizes or focuses on a particular outcome, game elements, and the like. In at least some embodiments, at least a portion of the game states are configured to have the same EV and/or include the same outcomes. Selection of a particular state is performed for a certain duration, which may be defined as a period of time, number of spins or outcomes, number of winning outcomes, and/or other suitable means of tracking game duration. In some embodiments, the duration may include achieving certain thresholds within the game feature, such as meeting a wager threshold amount or an award threshold amount. Selection of a game state from the available game states may be at least partially random, including selection of the current state for an additional duration.

The systems and methods described herein provide a technical solution to a technical problem arising from player engagement and regulatory considerations surrounding games with dynamic focus, That is, dynamic game focus on particular game outcomes and/or game elements is achieved through different game states having respective rules and/or weight parameters rather than generating outcomes and rearranging and/or replacing game elements in the generated outcome to provide the appearance of dynamic focus. Rearranging and/or replacing game elements may be impacting or limited by regulatory considerations and can add a substantial computing resource burden to the underlying gaming machine depending on the scale and scope of the rearrangement and/or replacement sequence. For example, regulatory considerations may prevent certain high-value symbols from being replaced and/or symbols associated with winning outcomes that are not within the scope of the current game focus, thereby introducing several additional steps to processing a game outcome (e.g., analyze the symbols of the initial outcome, identify symbols that are not to be replaced based on stored rules, determine how to replace or reorganize the remaining symbols, etc.). These additional steps are realized through additional computing instructions executed the game-logic circuitry, such as additional random number generation, retrieving and applying regulatory-approved rules for reorganizing the game outcome. Rather, the systems and methods described herein provide dynamic focus through predefined states rather than requiring each game outcome to be analyzed and altered, thereby reducing the computing burden of the game feature on the gaming machine (or game-logic circuitry), Moreover, for embodiments in which game state selection occurs after a plurality of game outcomes, the computing burden of the systems and methods described herein are further reduced relative to the alteration of each game outcome. Accordingly, the systems and methods described herein provide a technical improvement to gaming systems configured for dynamic game focus by providing such dynamic focus in an enhanced, efficient manner, thereby freeing computational resources to perform other tasks of the gaming system.

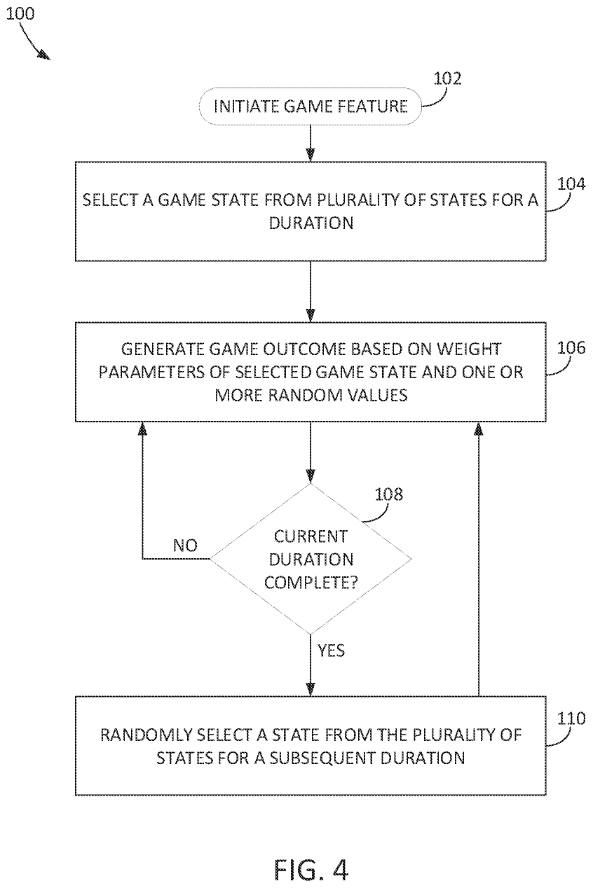

Referring now to FIG. 4, a flow diagram of an example method 100 of conducting a multi-state game feature using a gaming system is provided. The method 100 is at least partially performed by game-logic circuitry (e.g., the game-logic circuitry 40, shown in FIG. 2) in communication with one or more display devices of a gaming machine, such as the machine 10 shown in FIGS. 1 and 2. The one or more display devices are configured to present one or more game interfaces for the multi-state game feature described herein. The game-logic circuitry is integrated within the gaming machine or at least partially included within a separate device a server) in communication with the gaming machine. In other embodiments, the method 100 is at least partially performed by another suitable device of the gaming system and/or includes additional, fewer, or alternative steps, including those described elsewhere herein.

At step 102, the game feature is initiated. The game feature may be a base or default game feature of a game having a plurality of states, where other game features are initiated through the base game feature (directly or indirectly). In other embodiments, the game feature is a bonus game feature that is initiated in response to a trigger event or trigger conditions present in a corresponding base game feature.

Initiating the game feature includes establishing a credit balance for the player. The credit balance is established through a credit input, which may include credits provided to the player (i.e., free credits) and/or credit provided by the player. The player-provided credits may be detected through one or more physical items representing credits (e.g., coins, bills, tickets, cards, visual codes, etc.) and/or allocation of funds through a digital player wallet, account, and the like. The credit balance may be used to fund wagers placed during the game. The credit balance is retrievable by the player by initiating a payout sequence, where the payout sequence concludes the game and provides a physical and/or digital representation of the remaining credit balance to the player. In some embodiments, the game and game features described herein are used for casual games, where the credit balance, wagers, and awards have no monetary value. However, the credit balance of such embodiments may be handled the same or similar to embodiments with credit balances having monetary value. That is, the remaining credits may be assigned to a player account associated with the player, associated with a printed ticket or card, and the like.

In at least some embodiments, the game feature described herein includes a plurality of symbol positions that are randomly populated with symbols to determine a game outcome. For example, the symbol positions may be arranged into a symbol array similar to the array shown in FIG. 3. In certain embodiments, population of the symbol positions is performed using one or more symbol-bearing reel strips. Each reel strip is associated with one or more symbol positions such that the associated symbol positions present a respective symbol from the reel strip.

In other embodiments, other suitable game features with symbol positions or other means of generating and presenting random game outcomes that can be configured to operate within a plurality of states as described herein are considered within the spirit and scope of the present disclosure. For example, one suitable game feature may include one or more segmented wheels that generate outcomes by selecting segments from each wheel, where the selection of segments may be different between different game states. For the clarity purposes, the game feature described herein includes a symbol array populated by randomly selected symbols, though the features, functions, and configurations of the game feature described herein may be applied to other suitable forms of the game feature.

In the example embodiment, the game feature includes a plurality of states. These states define one or more underlying parameters that impact how the game outcomes of the game feature are determined. In at least some embodiments, the states affect or alter the random selection of certain game symbols or certain reel stop positions, the available symbols, the reel compositions, and/or other suitable parameters that impact the game outcome. In certain embodiments, other aspects of the game feature that do not impact the game outcome may be changed between states, such as the appearance of the game interface of the game feature. In the example embodiment, each state has a respective set of weight parameters (which may include one weight parameter in some embodiments), where the weight parameters are applied to one or more random determinations to generate an outcome for the game. For example, a random value may be compared to a weighted table that indicates the available outcomes for the game feature, where the comparison determines which outcome is generated. The weighting of the table expands or contracts the range of values that represent each game outcome.

Other suitable weighting parameters may be used, particularly for embodiments with other means of randomly determining game outcomes. For example, a single outcome may not be generated through a single comparison of a weighted table and random value. Rather, a weighted table and random value may be compared for each reel strip, symbol position, and/or other subset of the symbol positions to determine which symbol(s) to present within the game outcome. The weight parameters may affect all or some of the weighted tables in such embodiments. In another example, the weight parameters affect the generation of the random values rather than modify the table of available outcomes. For example, the weight parameters may add an offset to the random value generated by the game-logic circuitry, modify the range or seed used to generate the random value, and/or the random value may be modified through one or more mathematical or logical functions including the weight parameters.

At step 104, the game-logic circuitry selects a state from the plurality of states for a first duration of the game feature. Selection of a state may be random, partially random, manually selected, and/or predetermined. In one example, the game feature automatically begins in a. predetermined state each time the game feature is initiated 102. In another example, the player may be provided the option to provide player input that selects one of the states. In a further example, one or more random determinations are used to select one of the states at step 104. In such an example, the states may be equally weighted (i.e., no weight parameters or equal weight parameters are applied to each state) or have heterogenous weights such that one or more states are favored over other states. In another example, the state is selected (randomly or otherwise) from a subset of the plurality of states. The subset may be predefined or dynamic, where the states within the subset are based on events and/or parameters of the game, randomly selected, and/or other suitable means of dynamically defining the subset. Selecting a state may include retrieving the associated weight parameters and/or other variables associated with the selected state for use in generating subsequent game outcomes and the like as described herein. In certain embodiments, each set of weight parameters is stored as a respective weighted table such that the weighted table associated with the selected state is retrieved.

The duration of the selected state is defined through one or more quantifiable parameters. In one example, the duration is expressed as a period of time, such as a period of real time or a period of in-game time (e.g., pausing the game also pauses the time count). In another example, the duration is expressed as a count of game events or game conditions, such as, and without limitation, a count of game outcomes, winning game outcomes, losing game outcomes, game outcomes with or without a certain symbol type or symbol combination, a number of symbols of a particular symbol type appearing in the symbol positions, and/or the like. In a further example, particularly in environments with multiple gaming machines configured to participate in the game feature, game events and/or conditions from other gaming machines may impact the duration. In certain embodiments, a combination of quantifiable parameters may define the duration. For example, the duration may include both a period of time and a number of game outcomes, where the duration expires when one or both of the counts have been met. The duration may be defined through one or more stored variables to enable the game-logic circuitry to determine whether or not the duration has expired, In one example, the game-logic circuitry generates a counter for the duration that is updated throughout the duration and a termination count, where the counter is compared to the termination count to determine if the duration has expired. The current count of the counter may be configured to increase or decrease towards the termination count (e.g., zero).

The duration of the selected state may be predetermined or dynamic. In one example, the duration of each state is the same (e.g., three, five, or ten game outcomes). in another example, the duration of each state is predetermined but varies for each state. In a further example, the duration is at least partially randomly determined. In such an example, the duration may be selected from a range or set of available durations, such as a range of three to ten game outcomes. The means of generating or determining the duration may change between state selection as described herein. In certain embodiments, the duration is not limited to alterations at the time of state selection. That is, the current count and/or the termination count of the duration may be adjusted in response to game events or conditions (e.g., wager history, player history, etc.) to increase or decrease the current duration of a given state. In such embodiments, the initial duration of a selected state may be predetermined.

In some embodiments, the selection of the state and/or the duration may be presented to the player through one or more presentation elements of the gaming machine. That is, the lighting assemblies, speakers, display devices, and/or the like of the gaming machine may adjust in response to the selected state and/or the current count of the duration. In one example, each state has at least a visual theme such that the theme signals to the player which state has been currently selected. In another example, as the current count of the duration changes, audiovisual changes may be made to the presentation by the gaming machine to indicate the next selection is approaching. In a further example, the one or more display devices of the gaming machine includes graphical elements that indicate the current state and/or the duration. In other embodiments, the current state and duration are not visually indicated beyond the inferred changes to the game outcomes from the parameters forming the current state (e.g., an increase in wild symbols appearing on the game interface can be inferred to be a game state favoring winning outcome types including wild symbols). In such embodiments, the changes to the current state may appear to be relatively seamless to the player.

At step 106, the game-logic circuitry generates a game outcome based at least partially on the weight parameters of the selected state and one or more random values. In at least some embodiments, the game outcome is generated in response to a wager provided by the player. The wager is deducted from a credit balance of the player. In some embodiments, the credit balance and wager have a monetary value such that the credit balance can be exchanged for a monetary value applied to an account of the player or monetary currency. In other embodiments, the credit balance and wager have no monetary value, and the game feature is implemented as a casual game.

As described above, in some embodiments, one or more random values are generated and compared to one or more tables. These tables include outcomes or symbols linked to one or more values such that matching the random value to a value of the table selects the corresponding outcome or symbol. The weight parameter or parameters modify the random value and/or the values of the table (e.g., assigning more or less values to a particular outcome or symbol). In at least some embodiments, each state has a respective weighted table incorporating the weight parameters. Other suitable means of generating outcomes through weight parameters and random values, such as selecting outcomes or symbols for the outcome through mathematical and/or logical functions including the weight parameters and random values, as considered to be within the spirit and scope of the present disclosure.

In at least some embodiments, the different games states favor a particular type of winning outcome. Types of winning outcomes may include, for example and without limitation, reel array pay types (e.g., awards provided for various symbol combinations, such as pay lines or scatter pays), bonus game triggers, wild symbol pays, and combinations and variations thereof. It is to be understood that “favoring,” a particular type of winning outcome means that the weight parameters increase the probability of a particular type or symbol or combinations of symbols to be present within the game outcome, thereby increasing the probability of particular type of winning outcome (or other outcome) of the game feature to be triggered in comparison to other types of outcomes available within the game feature. The remaining types of winning outcomes may still be available, but at a lower probability in comparison to the favored type of winning outcome. For example, if the current state favors scatter pays, then the corresponding weight parameters may include the probability of achieving a winning scatter outcome in comparison to an outcome that triggers a bonus game feature. Similarly, transitioning to a state that favors bonus game triggers may increase the probability of the game outcome including a threshold number of bonus trigger symbols. In certain embodiments, each winning outcome type is associated with a particular state. In other embodiments, multiple states may favor a particular winning outcome type with different parameters. For example, a first state and a second state may favor line pays, but the first state favors the inclusion of wild symbols in generated game outcomes while the second state favors aligning certain symbol combinations.

In at least some embodiments, each game state includes the same set of available outcomes, where the weight parameters influence the probability of achieving each outcome. In such embodiments, winning outcomes other than the outcomes favored by the current state are still available to the player for a generated outcome. For example, a scatter pay is still possible in a state that favors line pays or bonus game triggers. To preserve the winning outcome types between states, the weighted tables of each state include all available symbols for selection and the rules of determining any winning outcomes are preserved between states.

Table 1 presents an example set of available outcome types for three states of a multi-state game. In this example, all the outcome types are available between states, but the probabilities of achieving the different outcome types are altered to increase the probability of a particular type. The outcome types in Table 1 are winning outcomes, and therefore the remaining probability percentages not shown represent non-winning outcomes and/or other outcome types not shown in Table 1. However, increasing the probability a certain winning outcome type result in the symbols that form the outcome type to increase in appearance in non-winning outcomes. For example, in State 1 of Table 1, if the Outcome Type A includes line pays using wild symbols, wild symbols may have an increased presence in game outcomes relative to the other states of the game.

TABLE 1

| | Game | Game | Game |
|---|---|---|---|
| | State 1 | State 2 | State 3 |
| Outcome Type A | 15% | 1% | 3% |
| Outcome Type B | 5% | 17% | 4% |
| Outcome Type C | 2% | 4% | 15% |

It is to be understood that the probabilities in Table 1 are for exemplary purposes only, and that other probabilities can be calibrated for the game. These probabilities may be stored as single variables that affect the underlying parameters of the game associated with outcome determination or as a combination of variables for the underlying parameters. For example, the different probabilities may be represented by the variables defining the different weight parameters for each game state.

In at least some embodiments, in addition to or instead of providing all outcomes, each state has substantially the same expected value (EV) or payback percentage. It is to be understood that “substantially the same” in this context means the value of the payback percentage of each state is within one hundredth of a percentage point of the other states (e.g., payback percentage of all states is 91.35%, where any variance below two decimal places is deemed non-substantive). The particular EV of the states may be established at any suitable value in accordance with regulation and/or other considerations, such as player engagement. Calibration of the EV for each state (and the game as a whole) is achieved through adjustments to the weight parameters and/or the awards for each winning outcome. In certain embodiments, one or more states may have a different EV. In such embodiments, each state may have a different EV, or a portion of the states maintain the same EV while the remaining portion of the states has different EVs.

In certain embodiments, at least some states have a different set of available outcomes in comparison to other states. That is, the set of available outcomes may be unique to a particular game state or partially overlapping the outcomes of other states. The different set of available outcomes may be implemented by adding or removing certain symbols for the available symbols and/or adding, removing, or modifying the rules of determining winning outcomes. In one example, the state may include additional multiplier symbols or other suitable symbols that facilitate new winning outcomes. In another example, the state may remove bonus trigger symbols from the set(s) of available symbols, thereby preventing a bonus game from being triggered. In a further example, the rules defining scatter pays are suspending in the state. In these embodiments, the EV of the states may remain the same between all states, or the changes to outcomes may result in a different EV between states.

In the example embodiment, after generating the game outcome, the game-logic circuity causes the display device to present the game outcome and determines whether any winning outcomes are present. If a winning outcome is detected, the game-logic circuitry causes the display device to present an award sequence associated with the detected winning outcome. The award sequence visually indicates the symbols included within the winning outcome and/or updates the credit balance of the player to include the award of the winning outcome.

At step 108, the game-logic circuitry determines whether or not the duration of the current state is complete or expired. In at least some embodiments, the current count of the duration is stored and updated through play of the game feature, and the determination at step 108 is performed by comparing the current count to a stored termination count. If the count matches or exceeds the termination count (including decreasing beyond the termination count), then the duration is deemed to be complete. However, if the comparison indicates the current count has not met or exceeded the termination count, then the current state continues. In such a result of the comparison, the game-logic circuitry continues to generate game outcomes at step 106 within the current state until the duration of the current state is deemed to be complete. At such determination, the game-logic circuitry progresses to step 110.

At step 110, the game-logic circuitry randomly selects a state from the plurality of states for a second duration subsequent to the first duration. The selection may be similar to the selection performed at step 104 or different. For example, the game feature may include selecting a predetermined state at step 104 and randomly selecting subsequent states at step 110. In sonic embodiments, the state selection at step 110 may include the current state such that selection of the current state would continue the current state for at least the second duration. In other embodiments, the current state and/or other states are not available for the selection at step 110. That is, a subset of the states may be available for selection in such embodiments, where the subset may be changed between each selection.

In certain embodiments, the selection of the next state may be weighted to increase or decrease the probability of selecting a particular state. For example, the current state may be weighted to reduce the chance of continued selection. In another example, a particular predefined path through the states may be favored by establishing certain weighting to the different states. In some embodiments, the player may be provided the option to manually set weighting to the different states to enable the player to increase the chance of selecting a preferred state. The weighting of the states may be predetermined or dynamic based on the conditions and events associated with the game.

Table 2 depicts an example progression between three game state of the game feature. Each column of Table 2 represents the current state of the game, and each row represents the subsequent state. For example, State 1 has a 47% chance of transitioning to State 2, 41% chance of transitioning to State 3, and 12% chance of remaining in State 1. The different probabilities may influence the progression of the game without defining a predetermined progression. In embodiments where transitioning between states happens a plurality of times through play of the game, the functionality described above provides both a game design and technical advantage over systems with predefined progression through states. That is, the random nature of state changes provides unexpected variety of play to the players, which can be desirable in games having different states or focused game aspects. Other systems may rely upon storing extended predetermined progressions through states and/or determining state changes through game events. In comparison to such systems, the storage of the variables defining the weight parameters and the random determination of progression of the systems and methods described herein provide the technical advantage of variable progression through multi-state games with reduced storage and/or computing burden attributed to the progression, thereby freeing these resources for other tasks and aspects of the system (including those tasks and aspects outside of the scope of the present disclosure).

TABLE 2

| Next State | State 1 | State 2 | State 3 |
|---|---|---|---|
| State 1 | 12% | 34% | 28% |
| State 2 | 47% | 33% | 67% |
| State 3 | 41% | 33% | 5% |

In some embodiments, the transition between states is represented through changes to one or more presentation elements of the gaming machine. That is, the presentation associated with the game (e.g., visual elements, audio elements, tactile elements, etc.) may change prior to, during, and/or after the transition between states. In certain embodiments, the transition between states is indicated by text elements presented by the display device. In other embodiments, the transition between states is not indicated by the presentation elements of the gaming machine (with the exception of the changes associated with the weight parameters, such as a particular type of symbol appearing more frequently in game outcomes). In such embodiments, the transition between states may be relatively seamless to the player, particularly for embodiments in which all outcomes are available between states.

In the example embodiment, the game-logic circuitry repeats steps 106-110 for the selected state within the second duration. That is, the game-logic circuitry generates one or more game outcomes within the selected state until the second duration is complete and selects yet another subsequent state for continued play of the game feature. The game feature may continue in such a manner until the game feature is terminated and/or another game feature is initiated. Terminating the game feature may occur, for example, in response to the player providing input to initiate a payout sequence, where the credit balance of the player is provided to the player via digital and/or physical representations of the balance, In some embodiments, the game feature may be suspended for certain game features. For example, a bonus game feature of the game may be triggered from the game feature, and triggering the bonus game feature may suspend the conditions and parameters of the game feature until the bonus game feature concludes. That is, the duration may not include time or outcomes from the bonus game feature (i.e., the duration is “paused” during the bonus game feature), and/or the state prior to triggering the bonus game feature may be resumed after the bonus game feature concludes.

In the illustrated embodiment, the steps 108 and 110 are linked to and follow the generation and presentation of game outcomes in step 106. However, in other embodiments, the steps 108 may occur in a different order relative to each other and step 106, including parallel execution of the steps. For example, if the duration is a period of time rather than a number of outcomes, the outcome generation may not have an impact on the determination at step 108. In another example, the selection of the next state may not be determined after the current duration has expired, but rather prior to the duration expiring. In such examples, a plurality of state transitions and durations may be determined at once to take advantage of the processing speed and task scheduling the game-logic circuitry to define a state sequence while preserving the variable nature of the game feature. Other suitable configurations of the steps 106-110 may be used to provide the functionality of the system executing the method 100.

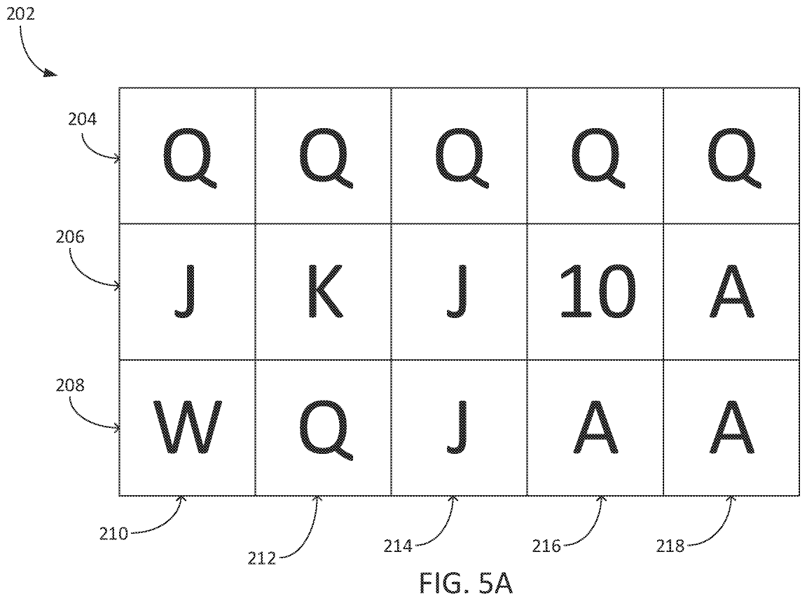

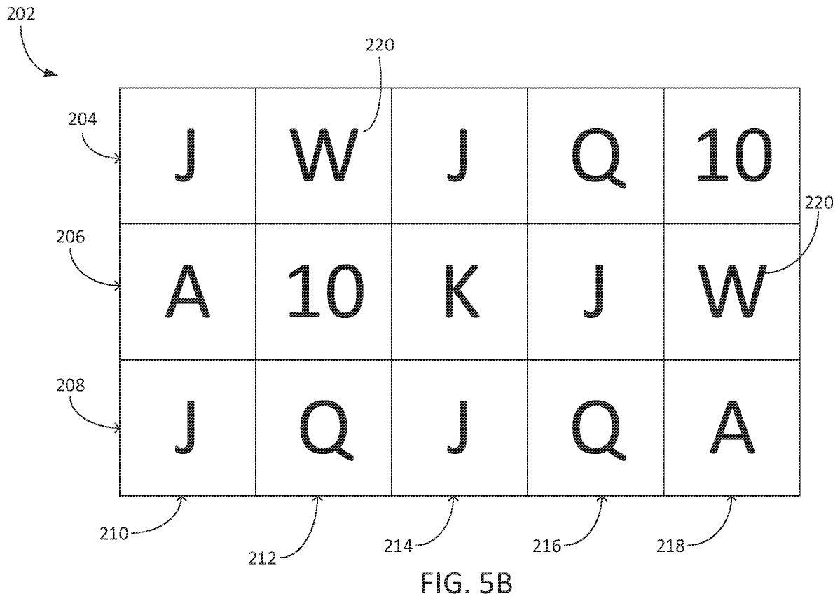

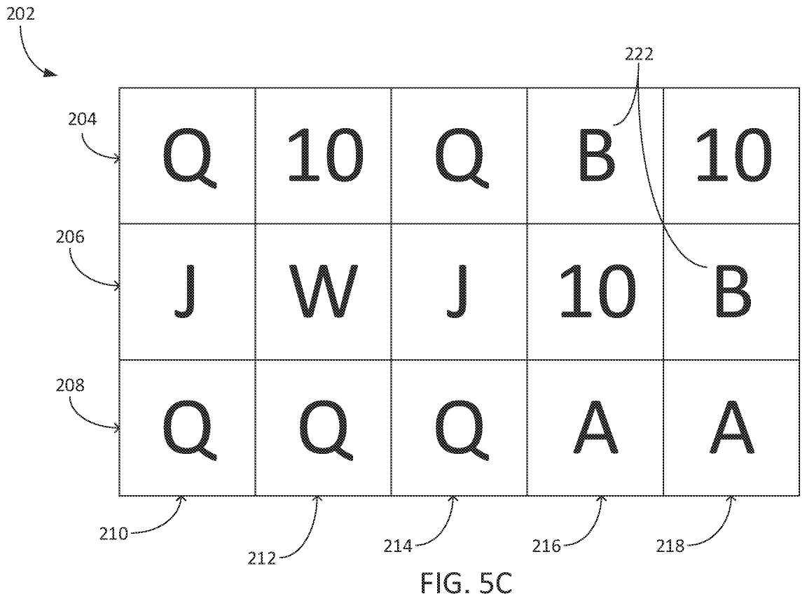

FIGS. 5A-5C depict game interfaces of an example game feature according to the embodiments described herein. More specifically, the game interfaces of FIGS. 5A-5C depict three example game states of the game feature, where the game feature may transition between the three states according to the method 100 (shown in FIG. 4). The game interfaces are shown by one or more display devices in communication with game-logic circuitry of a gaming system similar to the system shown in FIGS. 1 and 2.

The game interfaces of FIGS. 5A-5C include a plurality of symbol positions. The symbol positions are organized into rows and columns to form a symbol array 202. More specifically, the symbol array 202 includes symbol positions organized into three rows 204, 206, and 208 and five columns 210, 212, 214, 216, and 218. In other embodiments, other suitable configurations of symbol positions may be used (including configurations with multiple arrays and/or independent symbol positions).

The symbol array 202 is populated by randomly selected symbols. The randomly selected symbols are selected from one or more sets of available symbols. In at least some embodiments, each set of available symbols is a symbol-bearing reel strip. Each reel strip is associated with one or more symbol position (e.g., each reel strip is associated with a respective column of the array 202). In other embodiments, additional or alternative sets of available symbols are provided. To select symbols from the sets of the available symbols, one or more random determinations, such as generating one or more random numbers, are used. For example, the symbols, combinations of symbols, outcomes, and the like may be stored within a weighted table. That is, each “entry” or selectable item in the table is associated with a respective weight parameter or combination of parameters that influence the probability of selecting the associated entry. As described with respect to FIG. 4, the weight parameters are adjustable to influence the probabilities of selecting certain symbols or achieving certain game outcomes. In some embodiments, the weight parameters are adjusted by modifying the underlying variables representing the weight parameters. In other embodiments, for different game states, different sets of weight parameters are stored and retrieved for use depending on the current game state. Other suitable means of applying weighting parameters to the selection of symbols may be used, including those described elsewhere herein.

In the example embodiment, FIG. 5A depicts the game interface of the game in a first game state. The first game state is associated with weight parameters that favor payline-based outcomes over other winning outcome types, particularly left-to-right pays (i.e., combinations of symbols are determined from the leftmost column 210 towards the rightmost column 218). That is, the weight parameters increase the probability of aligning a plurality of symbols along a payline. In the illustrated example, a payline is defined across the upper row 204, and five “Q” symbols have aligned to result in a winning outcome. Although the illustrated example includes a winning outcome, the first game state may also increase the chance or probability of “near-miss” outcomes associated with paylines. A near-miss outcome is an outcome that a player recognizes as achieving some but not all conditions for a winning outcome. An example for a left-to-tight payline outcome type would be the second or third column 212, 214 including a symbol other than a “Q” symbol in the upper row 204, thereby breaking the string of symbols. These near-miss outcomes are also a product of the weight parameters associated with the first game state.

The game feature is configured to generate one or more game outcomes in the first game state. The duration of the first game state may be defined through a measure of time, a quantity of game events (e.g., number of game outcomes or winning outcomes), and/or other suitable events or conditions associated with the game feature. In certain embodiments, the player is provided the ability to set or modify the duration of a particular game state, thereby enabling the player to customize the game feature according to his or her preferences.

In the example embodiment, following the duration of the first game state completing, the game feature transitions to a second game state for a second duration. The second duration may be the same as the duration of the first game state or dynamically determined. The selection of the second game state may be predetermined or dynamic such that the path between game states is randomly and/or dynamically determined. For example, in at least some embodiments, the selection process following the first game state may include other potential game states beyond the second game state, including the first game state for an additional duration. The selection may be weighted to increase or decrease the probability of selecting certain game states. The weighting may be based on the current state, past states, and/or other conditions of the game feature (e.g., the player may have previously provided a preference for certain game states, which may affect the weighting of the game states). In other embodiments, no weighting is provided for the state selection.

FIG. 5B depicts the game interface associated with the second game state. In the example embodiment, the second game state includes weight parameters that favors scatter pays with wild symbols 220. That is, winning outcome types favored in the second game state account for the number of a particular type of game symbol in addition to any wild symbols 220 in the array 202. The wild symbols 220 may be limited to determining scatter pays, or the wild symbols 220 may be factored into other winning outcome types, such as payline-based winning outcomes. In other embodiments, the second game state does not favor wild symbols 220 and/or does not include the wild symbols 220 in determining scatter pays. Although the scatter pays are favored in the second game state, the payline-based winning outcomes favored by the first game state are still available in the example embodiment.

Multiple winning outcomes may be present in one game outcome. For example, a game outcome with a payline-based winning outcome may also include a scatter-based winning outcome, In certain embodiments, game outcomes with multiple winning outcomes may include rules or parameters to selectively apply one or a portion of the winning outcomes. For example, the highest-value winning outcome may be selected while other winning outcomes are not applied, In another example, overlapping winning outcomes (e.g., winning outcomes including at least one common symbols) may result in one of the overlapping winning outcomes to be selected based on the value of the outcomes and/or a priority ordered defined at least partially by winning outcome type. In other embodiments, all winning outcomes detected in the game outcome are provided.

In certain embodiments, at least some of the payline-based winning outcomes and/or other winning outcome types are disabled or inactive in the second game state. Converting certain winning outcome types from active to inactive may include, for example, modifying the sets of available symbols, modifying or removing the rules that define winning outcomes, and/or adjust the weight parameters to prevent certain symbols or outcomes from being selected (e.g., a weight of zero is applied to the inactive selection). Similar changes may be used to convert inactive winning outcome types to active winning outcome types.

Following the second game state, the game feature is transitioned to a third game state for a third duration, which may be the same or different from the durations of the first and second game states. FIG. 5C depicts the game interface associated with the third game state. More specifically, the third game state is configured to favor winning game outcome types that trigger a bonus game feature through bonus trigger symbols 222. In the example embodiment, a bonus game feature is triggered in response to a threshold number of bonus trigger symbols 222 appearing in the symbol array 202 in a game outcome. In one example, the threshold number is three. In another example, the bonus trigger symbols 222 are collectible over a plurality of game outcomes such that the current count of symbols 222 is persistent for a plurality of game outcomes. In other embodiments, other suitable means of triggering a bonus game feature are contemplated, such as certain symbol combinations or other game events or conditions.

The bonus game feature may be an array-based game feature similar to the feature shown in FIGS. 5A-5C, or the bonus game feature may include another form. The bonus game feature may provide potential awards, modifications to the base game feature, and/or other effects. The EV of the game states may factor in the awards of the bonus game feature and the probability of triggering the bonus game feature. For example, the reduced probability of other winning outcome types in the third game state relative to other game states may be offset by the increased probability of triggering the bonus game feature, particularly for embodiments in which the game states are calibrated to have substantially the same EV.

Although three different game states are shown in FIGS. 5A-SC for an example game feature, it is to be understood the foregoing systems and methods may be used for game features having a different configuration of game states. For example, other suitable game features may include additional, fewer, or alternative game states, including those described elsewhere herein. The game states may favor different winning outcome types or certain winning outcomes within a given winning outcome type. For example, a first and a second state may favor payline-based winning outcomes, but the first state favors paylines including wild symbols while the second state favors payline wins with reduced emphasis on wild symbols.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

1. A gaming machine comprising:
a display device configured to present a wagering game having a plurality of states, wherein each state of the plurality of states has substantially the same expected value, the same set of available outcomes relative to other states of the plurality of states, and a respective unique set of weight parameters associated with the set of available outcomes; and
game-logic circuitry configured to:
select a first state from the plurality of states for a first duration, the first state having a first set of weight parameters associated with the set of available outcomes;
generate at least one game outcome from the set of available outcomes through the first duration at least partially based on the first set of weight parameters and one or more random values;
cause the display device to present the generated at least one game outcome;
randomly select a state from the plurality of states for a second duration following the first duration; and
generate one or more game outcomes from the set of available outcomes through the second duration based on the respective set of weight parameters associated with the randomly selected state and one or more random values.

2. The gaming machine of claim 1, wherein the first duration is defined by a number of generated game outcomes, wherein the second duration is initiated in response to completion of the number of generated outcomes within the first duration.

3. The gaming machine of claim 2, wherein the number of generated game outcomes is randomly selected from a plurality of duration values.

4. The gaming machine of claim 1, wherein the first duration is defined by a period of time, wherein the second duration is initiated in response to expiration of the period of time within the first duration.

5. The gaming machine of claim 1, wherein each unique set of weight parameters emphasizes a winning outcome type of the set of available outcomes.

6. The gaming machine of claim 5, wherein the winning outcome type associated with the first set of weight parameters is different from the winning outcome type associated with a second set of weight parameters of a second state of the plurality of states.

7. The gaming machine of claim 6, wherein the winning outcome type associated with the first set of weight parameters is a reel array pay type and the winning outcome type associated with the second set of weight parameters is a bonus game trigger.

8. The gaming machine of claim 1, wherein the randomly selected state is the first state.

9. The gaming machine of claim 1, wherein randomly selecting a state for a subsequent duration is at least partially based on a current state of the wagering game.

10. A method of conducting a wagering game using a gaming system, the gaming system comprising game-logic circuitry and a display device of a gaming machine, the method comprising:
presenting, by the display device, the wagering game having a plurality of states, wherein each state of the plurality of states has substantially the same expected value, the same set of available outcomes relative to other states of the plurality of states, and a respective unique set of weight parameters associated with the set of available outcomes;
selecting, by the game-logic circuitry, a first state from the plurality of states for a first duration, the first state having a first set of weight parameters associated with the set of available outcomes;
generating, by the game-logic circuitry, at least one game outcome from the set of available outcomes through the first duration at least partially based on the first set of weight parameters and one or more random values;
causing, by the game-logic circuitry, the display device to present the generated at least one game outcome;
randomly selecting, by the game-logic, circuitry, a state from the plurality of states for a second duration following the first duration; and
generating, by the game-logic circuitry, one or more game outcomes from the set of available outcomes through the second duration based on the respective set of weight parameters associated with the randomly selected state and one or more random values.

11. The method of claim 10, wherein the first duration is defined by a number of generated game outcomes, wherein the second duration is initiated in response to completion of the number of generated outcomes within the first duration.

12. The method of claim 11, wherein the number of generated game outcomes is randomly selected from a plurality of duration values.

13. The method of claim 10, wherein the first duration is defined by a period of time, wherein the second duration is initiated in response to expiration of the period of time within the first duration.

14. The method of claim 10, wherein each unique set of weight parameters emphasizes a winning outcome type of the set of available outcomes.

15. The method of claim 14, wherein the winning outcome type associated with the first set of weight parameters is different from the winning outcome type associated with a second set of weight parameters of a second state of the plurality of states.

16. The method of claim 15, wherein the winning outcome type associated with the first set of weight parameters is a reel array pay type and the winning outcome type associated with the second set of weight parameters is a bonus game trigger.

17. The method of claim 10, wherein the randomly selected state is the first state.

18. The method of claim 10, wherein randomly selecting a state for a subsequent duration is at least partially based on a current state of the wagering game.

19. A gaming system comprising:
a gaming machine including a display device configured to present a wagering game having a plurality of states, wherein each state of the plurality of states has substantially the same expected value, the same set of available outcomes relative to other states of the plurality of states, and a respective unique set of weight parameters associated with the set of available outcomes; and
game-logic circuitry configured to:
select a first state from the plurality of states for a first duration, the first state having a first set of weight parameters associated with the set of available outcomes;
generate at least one game outcome from the set of available outcomes through the first duration at least partially based on the first set of weight parameters and one or more random values;
cause the display device to present the generated at least one game outcome;
randomly select a state from the plurality of states for a second duration following the first duration; and
generate one or more game outcomes from the set of available outcomes through the second duration based on the respective set of weight parameters associated with the randomly selected state and one or more random values.

20. The gaming system of claim 19, wherein the first duration is defined by a number of generated game outcomes, wherein the second duration is initiated in response to completion of the number of generated outcomes within the first duration.

21. The gaming system of claim 19, wherein the first duration is defined by a period of time, wherein the second duration is initiated in response to expiration of the period of time within the first duration.

22. The gaming system of claim 19, wherein each unique set of weight parameters emphasizes a winning outcome type of the set of available outcomes, and wherein the winning outcome type associated with the first set of weight parameters is a reel array pay type and the winning outcome type associated with a second set of weight parameters of a second state of the plurality of states is a bonus game trigger.

23. The gaming system of claim 19, wherein the randomly selected state is the first state.

24. The gaming system of claim 19, wherein randomly selecting a state for a subsequent duration is at least partially based on a current state of the wagering game.
